(19) United States
(12) Patent Application Publication
(10) Pub. No.: US 2020/0181934 A1
(43) Pub. Date: Jun. 11, 2020

(54) UMBRELLA HOLDER FOR A COOLER

(71) Applicant: Kenneth LeBlanc, Broomfield, CO (US)

(72) Inventor: Kenneth LeBlanc, Broomfield, CO (US)

(21) Appl. No.: 16/211,231

(22) Filed: Dec. 6, 2018

(51) Int. Cl. E04H 15/02; E04H 15/28; F16M 13/02; F16B 1/00; F16B 2/08; F16B 47/00

(52) U.S. Cl. CPC E04H 15/02; E04H 15/28; F16M 13/022; F16B 2001/0028; F16B 2/08; F16B 47/00; F16B 1/00

(57) ABSTRACT

An umbrella holder for a cooler is presented. The umbrella holder has a bracket which is used to attach the umbrella holder to the exterior of a cooler. The umbrella holder may be attached using screws, Velcro, a trap, or suction cups. Further the umbrella holder may be pivoted or swiveled to move the umbrella into a position to block the sun or wind.

### FIELD OF THE INVENTION

This invention relates to umbrella holders. More particularly, it relates to umbrella holders attached to coolers.

### BACKGROUND

Umbrellas are often used for shade, such as at a beach or park. The shade provided by an umbrella is desirable for several reasons, such as relief from the heat, or to avoid becoming sunburned. Beach umbrellas are typically fairly large, and can be difficult to anchor in some situations.

Particularly, some beaches may be rocky or be of heavy gravel, and not allow easy insertion of the umbrella pole into the soil. Similarly, it may be desirable to provide shade on a lawn, where it would be difficult and possibly inappropriate to drive an umbrella pole into the lawn.

One solution to providing support for a shade umbrella is a heavy base, such as are commonly known as a flag stand. Such supports are often seen in outdoor café's, for example, and usually have a large concrete, iron, or other heavy base with a socket in the center to accept the umbrella pole.

Often, the bases are circular to allow them to be rolled to the desired location because they are so heavy and awkward to carry. However, it is impractical for an individual to carry such a stand any appreciable distance, such as down to the beach. Such stands also generally only support the umbrella pole in a vertical direction. A tilting mechanism is commonly provided on cafe umbrellas; however, this feature is often omitted on beach umbrellas.

Another approach generally uses guy wires or ropes, in conjunction with spikes, to support the umbrella. This assumes that the guy ropes can be secured to something or that a spike can be driven into the soil so that a rope may be attached.

Not only do several soils, such as beach sand, provide a poor anchor, the guy ropes are inconvenient and create a tripping hazard. The umbrella is also cumbersome to move to another location, such as to adjust it for a change in the angle of the sunshine or in wind.

Some people fill buckets or bags with sand, rocks, or the like in order to make a support. However, one usually has enough to carry when going to the beach or park without additional bags and buckets, and it is usually desirable to spend one's time in pursuits other than filling a bag with sand or rocks.

### BRIEF DESCRIPTION OF THE DRAWINGS

FIG. 1 is a traditional cooler.

FIG. 2 is the traditional cooler of FIG. 1 with an exemplary umbrella holder.

### DETAILED DESCRIPTION

Reference will now be made in detail to the present preferred embodiments, examples of which are illustrated in the accompanying drawings. All terms in the plural shall also be taken as singular and vice-versa. Further, any reference to he shall also be applicable to she and vice-versa.

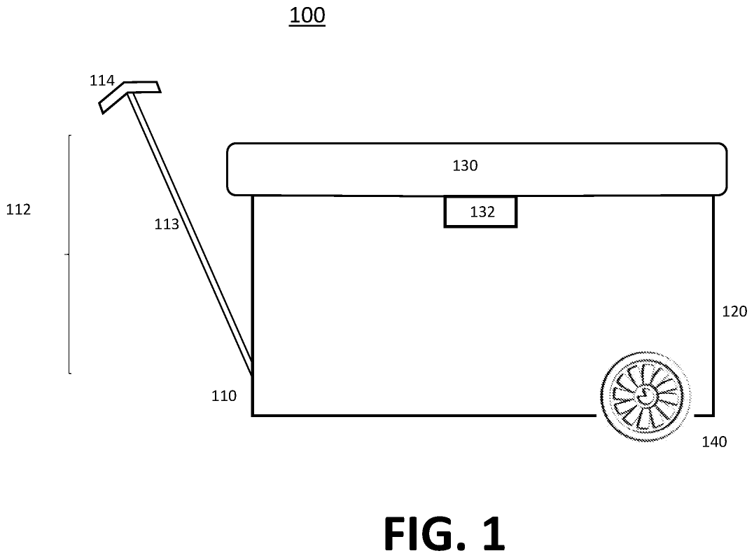

Referring to FIG. 1, is a traditional cooler 100. The traditional cooler 100 is useful for transporting food and drink that needs to be kept cool or in some cases kept warm or hot.

The traditional cooler 100 has a front end 110, a back end 120, and a top 130. The top 130 of the traditional cooler 100 has a latch 132 for locking or securing the top 130 to the traditional cooler 100 when the traditional cooler cart 100 is moving or in other cases.

The front 110 of the traditional cooler 100 has a handle 112 for pulling the traditional cooler 100 in a forward or pushing the traditional cooler cart 100 in a reverse direction. The handle 112 coupled to the front 110 of the traditional cooler 100 may be a pole 113 with holdable portion 114. The holdable portion 114 of the handle 112 fits into a hand or may be attached to a pully to pull or push the traditional cooler 100.

Located substantially near the back end 120 of the traditional cooler cart 100 is a wheel 140. The wheel 140 is useful for making the movement of the traditional cooler 100 easier and requires less effort from the person pulling or pushing the traditional cooler 100.

The wheel 140 of the traditional cooler 100 is also useful in keeping the traditional cart from having its bottom sitting on the ground and potentially reducing the lifetime of the traditional cooler 100. But the traditional cooler 100 does not have a block from the sun or wind or other elements in the environment.

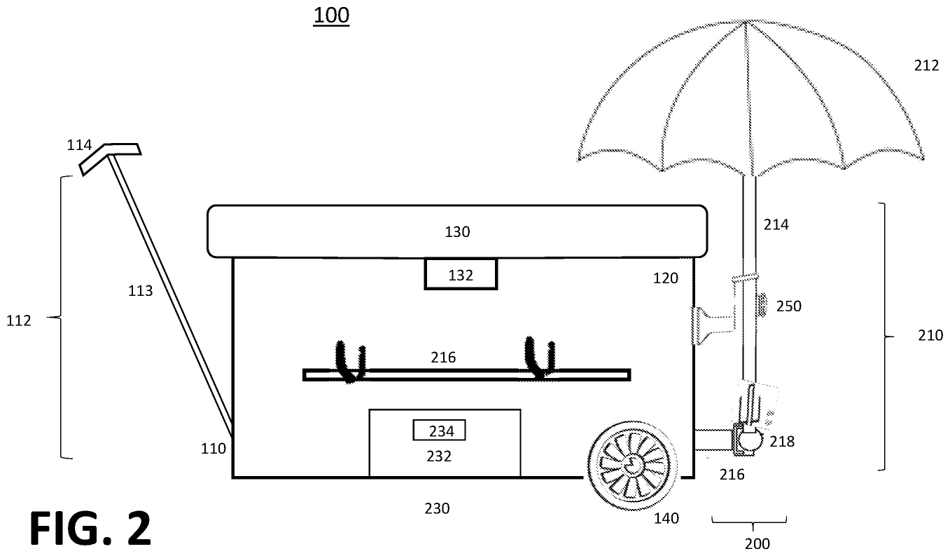

Moving now to FIG. 2, the traditional cooler 100 of FIG. 1 is shown with an exemplary umbrella holder. The umbrella holder 200 has a bracket 210. The bracket 210 is useful in holding an umbrella 212. The bracket 210 is adjustable to any size umbrella 212. The umbrella 212 has a pole 214. The pole 214 is secured to the bracket 210. The bracket 210 may be cylindrical, v-shaped, etc.

The brackets 210 are attached to the back end 120 or a side (not shown) of the cooler 100. The brackets 210 may be secured to the back end 120 or the side of the cooler 100 by any means such as by screws, Velcro, adhesive, straps, etc. The bracket 210 may be made from metal, polyvinyl chloride (PVC), etc. The brackets 210 may be permanently attached by epoxy, temporarily attached by a suction cup or straps, or may be removable for easy storage or easy use when no umbrella is necessary.

The pole 214 of the umbrella 212 may be made of one or more portions, where when there is more than one portion, the two portions are attached by a knob and screw mechanism 250 in which the umbrella 212 may be folded. The bracket 210 is a cylinder that may be made from metal, polyvinyl chloride (PVC) with a smaller half cylinder inside that tightens to the pole as the lever is slid down and put in the lock position.

The cooler has an umbrella bracket 216 attached to one side of the cooler 100. The umbrella bracket 216 is made to receive the folded umbrella 212 and to secure the umbrella 212 to the cooler 100. The umbrella bracket 216 may made from metal, polyvinyl chloride (PVC), elastic straps, Velcro, a strap, or a suction cup.

The umbrella pole 212 fits into a coupling of the bracket 250. The bracket 250 may be a swivel connector 218. The swivel connector 218 is useful in moving the umbrella 212 into a position to alleviate the cooler 100 and those near the cooler 100 from the elements such as wind, rain, snow, sun, etc. The swivel connector 218 may instead be a pivoting system.

The pole 214 slides into and couples into the swivel connector 218, further the umbrella pole 214 may have a knob, button or other mechanism (not shown) to allow the umbrella to bend, swivel or pivot into a different position than straight. Thus, the umbrella has multiple options to be adjusted and moved to an optimal position to block the environmental elements.

The cooler 100 may optionally have a cabinet 230 for storing umbrella accessories. The cabinet 230 has a door 232 and a handle 234. The handle 234 of the door 232 has a latch (not shown) on the inside of the cooler 100 to secure the door 232 to the cooler 100 when the door 232 has been closed.

The features described with respect to one embodiment may be applied to other embodiments or combined with or interchanged with the features of other embodiments, as appropriate, without departing from the scope of the present invention.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

1. An umbrella holder for a cooler, the umbrella holder comprising:
a bracket, the bracket having an umbrella pole holder where the bracket is attached to the exterior of a cooler; and
a swivel, wherein the swivel swivels the umbrella to block environmental elements.

2. The article of clothing of claim 1, wherein the umbrella holder rotates.

3. The umbrella holder of claim 1, wherein the umbrella holder is cylindrical.

4. The umbrella holder of claim 1, wherein the bracket is removably attachable.

5. The umbrella holder of claim 1, further comprising an umbrella, the umbrella being held in the umbrella holder.

6. The umbrella holder of claim 1, wherein the umbrella holder accepts one or more size of umbrellas.

7. The umbrella holder of claim 1, wherein the umbrella holder is foldable.

8. The umbrella holder of claim 1, wherein the bracket is attached to the exterior of the cooler using Velcro.

9. The umbrella holder of claim 1, wherein the bracket is attached to the exterior of the cooler using straps.

10. The umbrella holder of claim 1, wherein the bracket is attached to the exterior of the cooler using suction cups.

11. The umbrella holder of claim 1, wherein the umbrella holder being pivoted to be movable to a different position.

12. (canceled)

13. The umbrella holder of claim 1, further comprising an umbrella storage bracket, wherein an umbrella is coupled to the umbrella storage bracket when umbrella holder is folded.
